(19) United States
(12) Patent Application Publication
(10) Pub. No.: US 2025/0289155 A1
(43) Pub. Date: Sep. 18, 2025

(54) BREAD SLICER

(71) Applicant: Ya Gao, Shenzhen (CN)

(72) Inventors: Yuyun Huang, Shenzhen (CN); Ya Gao, Shenzhen (CN)

(21) Appl. No.: 18/966,785

(22) Filed: Dec. 3, 2024

(30) Foreign Application Priority Data
Mar. 18, 2024 (CN) 202420522241.1
Nov. 4, 2024 (CN) 202422691232.8

(51) Int. Cl. B26B 29/06

(52) U.S. Cl. CPC B26B 29/063

(57) ABSTRACT

The present disclosure relates to a bread slicer. The bread slicer includes a base plate and two grid plates mounted on the base plate, where the two grid plates are respectively located on two opposite sides of the base plate, and the base plate and the two grid plates enclose a placement space for placing bread; and the base plate includes a first plate and a second plate, the second plate is slidably connected to the first plate, and the second plate can slide relative to the first plate, so as to adjust a distance between the two grid plates. A user can adjust the distance between the grid plates by driving the second plate to slide relative to the first plate, thereby placing bread with different widths and sizes into the placement space.

### CROSS REFERENCE TO RELATED APPLICATION

This application claims priority benefit of Chinese patent Application No. 202420522241. 1, filed on Mar. 18, 2024, and No. 202422691232. 8, filed on Nov. 4, 2024, and the entire contents of which are incorporated herein by reference.

### TECHNICAL FIELD

The present disclosure relates to the technical field of furniture supplies, in particular to a bread slicer.

### BACKGROUND

A bread slicer is a practical article of daily use, and can facilitate a user to easily cut bread into uniform bread slices. However, in the existing design, the bread slicer cannot fix the bread with different widths, and when the user cuts the bread by means of the slicer, the bread is prone to sliding, resulting in non-uniform cut bread slices.

### SUMMARY

The present disclosure aims to provide a bread slicer, so as to solve the problems that an existing bread slicer cannot fix bread with different widths, and when a user cuts the bread by means of the slicer, the bread is prone to sliding, resulting in non-uniform cut bread slices.

To solve the above technical problems, the present disclosure adopts the following technical solution:
a bread slicer, comprising a base plate and two grid plates mounted on the base plate, where the two grid plates are respectively located on two opposite sides of the base plate, and the base plate and the two grid plates enclose a placement space for placing bread; and
the base plate comprises a first plate and a second plate, the second plate is slidably connected to the first plate, and the second plate is capable of sliding relative to the first plate, so as to adjust a distance between the two grid plates.

Optionally, the first plate is provided with sliding grooves, the second plate is provided with sliding portions, and the sliding portions are embedded into the sliding grooves, so that the second plate is capable of sliding relative to the first plate.

Optionally, there are two sliding grooves, and the two sliding grooves are respectively located on two opposite sides of the first plate; and the number and positions of the sliding portions match with the number and positions of the sliding grooves.

Optionally, the first plate further comprises rail holes, and the second plate is in damping connection with the rail holes; and
when the second plate is moved to a target distance under the action of an external force, the second plate is kept in a fixed state relative to the first plate.

Optionally, there are two rail holes, the two rail holes are respectively located on two opposite sides of the first plate, and the positions of the two rail holes match with the positions of the sliding grooves.

Optionally, the second plate is provided with threaded connection members, and one end of each of the threaded connection members movably penetrates through the rail hole and is connected to the second plate.

Optionally, further comprising a limiting plate, each of the grid plates comprises a plurality of limiting grooves formed at intervals, and the limiting plate is capable of being selectively inserted into the limiting grooves.

Optionally, the plurality of limiting grooves divide each of the grid plates into a plurality of grid plate sheets, and the widths of at least two of the grid plate sheets are the same and/or the widths of at least two of the grid plate sheets are different.

Optionally, one side of the limiting plate is turned outwards to form a limiting portion, and the limiting portion is provided with a plurality of clamping grooves; and
when the limiting plate is inserted into the limiting grooves, the grid plate sheets are embedded into the clamping grooves so as to limit sliding of the limiting plate relative to the grid plates.

Optionally, the base plate and the limiting plate each are provided with a plurality of through holes.

Optionally, the two grid plates are rotationally connected to the two opposite sides of the base plate, and the two grid plates are capable of respectively rotating relative to the base plate, so that the grid plates are switched between open positions and storage positions.

Optionally, further comprising a limiting plate, each of the grid plates is provided with a plurality of limiting grooves, and the limiting plate is capable of being selectively inserted into the limiting grooves.

Optionally, two opposite edges of the limiting plate are turned to form two limiting portions, and when the limiting plate is inserted into the limiting grooves, the two limiting portions respectively abut against outer sides of the two grid plates.

Optionally, mounting strips are respectively arranged on the other pair of opposite side edges of the base plate, the two mounting strips and the base plate form an accommodating groove, and when the grid plates are located at the storage positions, the grid plates are accommodated in the accommodating groove.

Optionally, each of the grid plates is provided with two connecting portions, the two connecting portions are arranged perpendicular to the grid plate and are respectively connected to the two mounting strips by means of bolts, and the connecting portions are rotationally connected to the bolts.

Optionally, the connecting portions are welded with the grid plates.

Optionally, each of the mounting strips is hollow, and connecting blocks are connected to end portions of the mounting strip.

Optionally, a non-slip pad is arranged at the bottom of each of the mounting strips.

Optionally, a support strip is arranged on a side edge of each of the grid plates opposite to a side edge close to the base plate, and the support strip and the grid plate are connected in an L shape.

Optionally, the base plate, the grid plates and the limiting plate are made of stainless steel materials.

It can be seen from the above technical solution that the embodiment of the present disclosure at least has the following advantages and positive effects:
in view of the bread slicer in the embodiment of the present disclosure, the user can adjust the distance between the grid plates by driving the second plate to slide relative to the first plate, thereby placing the bread with different widths and sizes into the placement space; after the bread is placed into the placement space, the second plate can also be driven to move relative to the first plate to enable the two grid plates to clamp and fix the bread, so that the bread is fixed more stably and cut more uniformly, and the operation is convenient in the whole process; and meanwhile, the bread slicer is simple in part composition and lower in cost.

### BRIEF DESCRIPTION OF THE DRAWINGS

In order to explain embodiments of the present disclosure or technical solutions in the prior art more clearly, drawings needed in descriptions of the embodiments or the prior art will be briefly introduced below. Obviously, the accompanying drawings in the following descriptions are only some embodiments of the present disclosure, and for a person of ordinary skill in the art, other drawings can be obtained according to structures shown in these accompanying drawings without involving any inventive effort.

FIG. 1 is an overall structural schematic diagram of a bread slicer in a first embodiment of the present disclosure;

FIG. 2 is a structural schematic diagram of the bread slicer as shown in FIG. 1 in a storage state;

FIG. 3 is an overall structural schematic diagram of a bread slicer in a second embodiment of the present disclosure;

FIG. 4 is an exploded structural schematic diagram of the bread slicer as shown in FIG. 3;

FIG. 5 is an exploded structural schematic diagram of a base plate as shown in FIG. 4 at another viewing angle;

FIG. 6 is a partial enlarged view of a grid plate and a limiting plate as shown in FIG. 4; and

FIG. 7 is a schematic diagram of the bread slicer as shown in FIG. 3 at a storage position.

The description of reference numerals is as follows:
1. base plate
2. grid plate
3. limiting plate
4. placement space
11. side edge
12. mounting strip
13. accommodating groove
14. non-slip pad
21. limiting groove
22. connecting portion
23. bolt
24. support strip
31. limiting portion
32. through hole
110. first plate
111. sliding groove
112. rail hole
120. second plate
121. connecting block
122. sliding portion
123. threaded connection member
210. grid plate sheet
310. clamping groove

### DETAILED DESCRIPTION OF EMBODIMENTS

Typical embodiments that show the characteristics and advantages of the present disclosure will be described in detail in the following description. It should be understood that the present disclosure can have various changes in different embodiments, which do not depart from the scope of the present disclosure. In addition, the description and drawings herein are essentially for the purpose of describing, instead of limiting the present disclosure.

Besides, the terms “first” and “second” are only for the purpose of describing, and cannot be understood as indicating or implying the relative importance or implicitly indicating the number of technical features indicated. Thus, the features defined as “first” and “second” may explicitly or implicitly include one or more such features. In the description of the present disclosure, unless otherwise explicitly specified, “a plurality of” means two or more.

In the description of the present disclosure, it should also be noted that unless otherwise specified and limited, the terms “arrangement”, “connecting” and “connection” should be understood in a broad sense, for example, they may be fixed connection, and may also be detachable connection or integrated connection; they may be mechanical connection, and may also be electrical connection; and they may be direct connection, and may also be indirect connection by means of intermediate media or communication of the interiors of two elements. For those of ordinary skill in the art, specific meanings of the above terms in the present disclosure can be understood according to specific circumstances.

### Embodiment 1

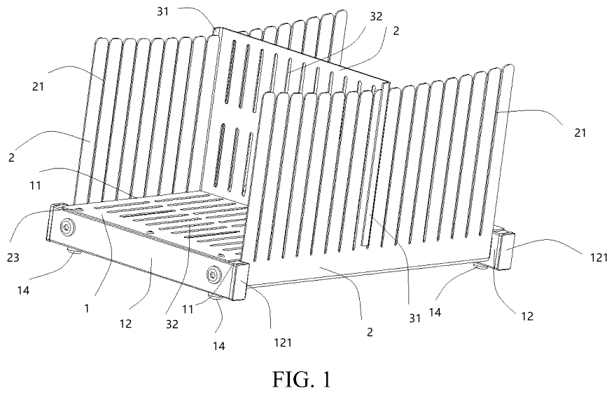

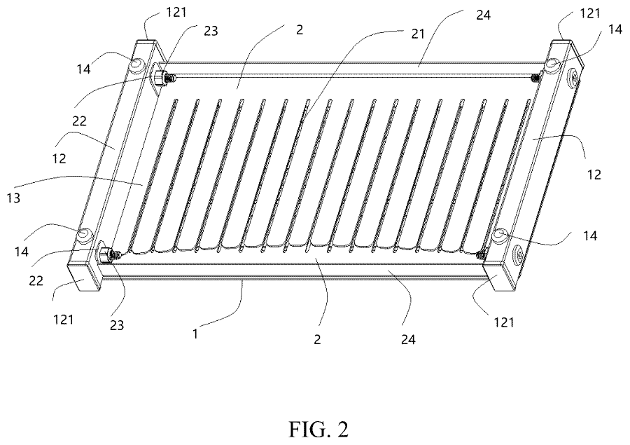

Reference is made to FIG. 1 and FIG. 2. A first embodiment of the present disclosure provides a bread slicer.

The bread slicer includes a base plate 1, grid plates 2 and a limiting plate 3, where there are two grid plates 2; the two grid plates 2 are respectively located on a pair of opposite side edges 11 of the base plate 1 and can rotate with the two side edges 11 as axes respectively; when each side edge 11 is in contact with the grid plate 2, the grid plate 2 is perpendicular to the base plate 1, and the base plate 1 blocks the rotation of the grid plate 2; when the base plate 1 is parallel to the two grid plates 2, the grid plates 2 are at storage positions; and each grid plate 2 is provided with a plurality of limiting grooves 21, and the limiting plate 3 can be selectively inserted into the limiting grooves 21. There are two grid plates 2, the two grid plates 2 are respectively located on the pair of opposite side edges 11 of the base plate 1 and can rotate with the two side edges 11 as the axes respectively, when each side edge 11 is in contact with the grid plate 2, the grid plate 2 is perpendicular to the base plate 1, and the base plate 1 blocks the rotation of the grid plate 2, and then the bread slicer is in a use state; and each grid plate 2 includes the plurality of limiting grooves 21, the limiting plate 3 can be selectively inserted into the limiting grooves 21, one end of bread abuts against the limiting plate 3, a cutter is placed into the limiting grooves 21 in sequence to cut the bread, and bread slices cut uniformly can be obtained very conveniently. The grid plates 2 are rotated, when the base plate 1 is parallel to the two grid plates 2, the grid plates 2 are at the storage positions, then the entire bread slicer is formed by stacking the base plate 1 and the two grid plates 2, the bread slicer is in a storage state, the size is smaller than that in the use state, and then the bread slicer is convenient to store and carry. Moreover, even if the base plate 1 is set to be very wide, it cannot greatly affect the storage, so that the base plate 1 can be made wider, thereby facilitating accommodating and matching bread with larger sizes.

Two opposite edges of the limiting plate 3 are turned to form two limiting portions 31, and flanges are easy to form and produce. When the limiting plate 3 is inserted into the limiting grooves 21, the two limiting portions 31 respectively abut against outer sides of the two grid plates 2, so that the limiting plate 3 is clamped with the limiting grooves 21, the limiting plate 3 can be maintained stable to limit the bread, and the bread is prevented from moving during slicing. In addition, the limiting plate 3 can be movably connected to any limiting groove 21, so that it is convenient to use.

In this embodiment, the two opposite edges of the limiting plate 3 are turned in the same direction to form the two limiting portions 31, so that a surface opposite to the limiting portions 31 is a plane, the limiting plate 3, the grid plates 2 and the base plate 1 can be conveniently stacked, and storage is further facilitated.

Mounting strips 12 are arranged on the other pair of opposite side edges of the base plate 1 respectively, the mounting strips 12 are configured to support the base plate 1, the two mounting strips 12 and the base plate 1 form an accommodating groove 13, when the grid plates 2 are located at the storage positions, the grid plates 2 are accommodated in the accommodating groove 13, and the accommodating groove 13 provides an accommodating space for the grid plates 2, so that the bread slicer is more convenient to store.

Each grid plate 2 is provided with two connecting portions 22, the two connecting portions 22 are arranged perpendicular to the grid plate 2 and are respectively connected to the two mounting strips 12 by means of bolts 23, and the connecting portions 22 are rotationally connected to the bolts 23, so that the grid plate 2 can rotate around the side edge 11 of the base plate 1, and the structure is simple and convenient to implement.

The connecting portions 22 are welded to the grid plates 2 and are closely connected to the grid plates, and the connecting portions 22 are not prone to falling.

In this embodiment, the two edges of the base plate 1 respectively abut against surfaces of the two mounting strips 12, the base plate 1 is connected to the mounting strips 12 by means of the bolts 23, and the connecting structures of the base plate 1 with the mounting strips 12 are simple and convenient to produce.

Each mounting strip 12 is hollow, and connecting blocks 121 are connected to end portions thereof; the hollow configuration is configured to reduce the weight of the mounting strip 12, thereby further facilitating carrying; and the two ends of the mounting strip 12 are sealed by means of the connecting blocks 121, thereby preventing foreign matters from entering it.

A non-slip pad 14 is arranged at the bottom of each mounting strip 12, thereby avoiding non-uniform bread slices caused by the fact that the mounting strip 12 slides to affect cutting during bread slicing.

In this embodiment, there are four non-slip pads 14, which are respectively located at two ends of the two mounting strips 12, thereby further preventing the mounting strips 12 from sliding.

A support strip 24 is arranged on a side edge of each grid plate 2 opposite to a side edge close to the base plate 1, and the support strip 24 and the grid plate 2 are connected in an L shape. When the grid plates 2 are located at the storage positions, the support strips 24 and the mounting strips 12 enclose a frame, the limiting plate 3 can be stacked on the grid plates 2, the frame can limit the limiting plate 3, and the limiting plate 3 can be stored together, thereby further facilitating the storage of the bread slicer.

The base plate 1 and the limiting plate 3 each are provided with a plurality of through holes 32, thereby reducing the weight of the base plate 1 and the limiting plate 3, and further facilitating carrying.

The base plate 1, the grid plates 2 and the limiting plate 3 are made of stainless steel materials, which are firm and durable.

In other embodiments, the base plate 1, the grid plates 2 and the limiting plate 3 also be set to be made of wood materials, which are lower in weight, thereby further facilitating carrying.

### Embodiment 2

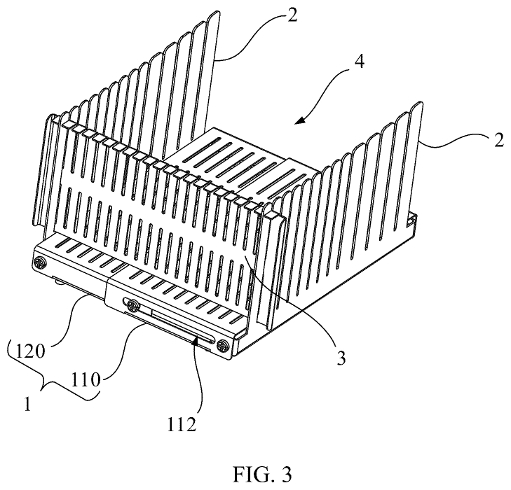

FIG. 3 to FIG. 7 show the second embodiment of the present disclosure. In the second embodiment, the base plate 1 is improved on the basis of the first embodiment. The base plate 1 includes a first plate 110 and a second plate 120, and the second plate 120 can slide relative to the first plate 110 to adapt to bread with different widths. Some structures in the second embodiment can refer to the description in the first embodiment.

Reference is made to FIG. 3. The second embodiment of the present disclosure provides a bread slicer. The bread slicer is used for uniformly cutting the bread. It should be noted that the bread slicer can also be used for cutting food such as noodles and cakes, which also falls within the scope of protection of the present disclosure.

FIG. 3 shows that the bread slicer includes a base plate 1 and two grid plates 2 mounted on the base plate 1, where the two grid plates 2 are respectively located on two opposite sides of the base plate 1, and the base plate 1 and the two grid plates 2 enclose a placement space 4 for placing bread.

When using the bread slicer, a user can first place the bread slicer on a support surface, then place the bread into the placement space 4, and finally cut the bread by means of a cutter. The bread slicer plays a role in fixing the bread, so as to prevent the situation that the cutting effect is affected due to sliding of the bread in a cut process. It is understandable that the support surface can be positions such as a desktop, a tabletop and a floor.

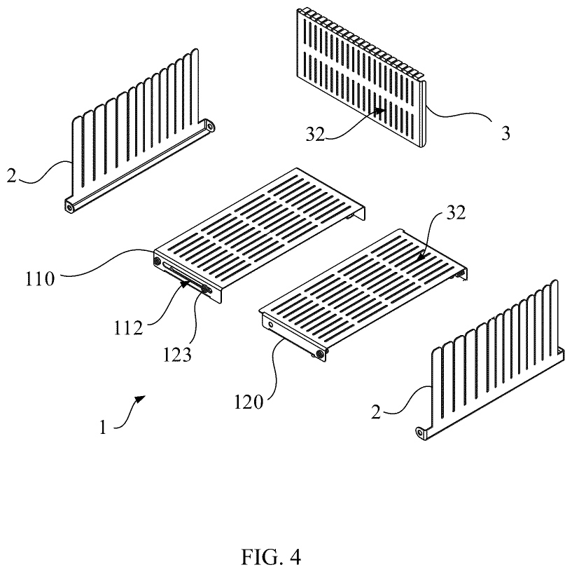

Reference is made to FIG. 3 and FIG. 4 together. In the present disclosure, the base plate 1 includes the first plate 110 and the second plate 120, the second plate 120 is slidably connected to the first plate 110, and the second plate 120 can slide relative to the first plate 110, so as to adjust a distance between the two grid plates 2. Thus, the user can adjust the distance between the grid plates 2 by driving the second plate 120 to slide relative to the first plate 110, thereby placing the bread with different widths and sizes into the placement space 4; after the bread is placed into the placement space 4, the second plate 120 can also be driven to move relative to the first plate 110 to enable the two grid plates 2 to clamp and fix the bread, so that the bread is fixed more stably and cut more uniformly, and the operation is convenient in the whole process; and the bread slicer is simple in part composition and lower in cost.

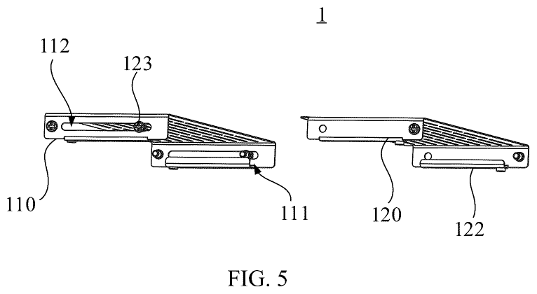

Reference is made to FIG. 5. In this embodiment, the first plate 110 is provided with sliding grooves 111, the second plate 120 is provided with sliding portions 122 matched with the sliding grooves 111, and the sliding portions 122 are embedded into the sliding grooves 111, so that the second plate 120 can slide relative to the first plate 110, and the sliding process is smoother.

Specifically, there are two sliding grooves 111, and the two sliding grooves 111 are respectively located on two opposite sides of the first plate 110; and the number and positions of the sliding portions 122 match with the number and positions of the sliding grooves 111, and there may be two, four or six sliding portions 122, that is, there may be one, two or three sliding portions 122 corresponding to each sliding groove 111. Thus, the resistance can be lower when the second plate 120 slides relative to the first plate 110, and the two sides of the second plate 120 are uniformly stressed and are not prone to jamming.

Reference is made to FIG. 4 and FIG. 5 together. In this embodiment, the first plate 110 further includes rail holes 112, and the second plate 120 is in damping connection with the rail holes 112; and when the second plate 120 is moved to a target distance under the action of an external force, the second plate 120 is kept in a fixed state relative to the first plate 110. Thus, the rail holes 112 play a role in guiding the sliding of the second plate 120 relative to the first plate 110, and the second plate 120 slides more stably relative to the first plate 110. Besides, the first plate 110 is in damping connection with the rail holes 112, in the process of fixing the bread, the user only needs to push the two grid plates 2 to get close to or away from each other to adapt to the width of the bread, and when the bread slicer is adjusted to the target width, the second plate 120 and the first plate 110 are kept fixed relative to each other, so that the bread can be clamped, and the operation is easy and convenient.

It should be noted that the target distance in the present disclosure is not limited to a specific value, and the target distance means that the user adjusts the distance between the two grid plates 2 to the appropriate size according to the bread with the different widths.

Specifically, the second plate 120 is provided with threaded connection members 123, one end of each threaded connection member 123 movably penetrates through the rail hole 112 and is connected to the second plate 120, and the other end of the threaded connection member 123 is exposed out of the first plate 110. Thus, the user can conveniently adjust the tightness degree of the threaded connection members 123, thereby adjusting the damping connection force of the second plate 120 with the rail holes 112.

Of course, in other embodiments, the second plate 120 can also be in damping connection with the rail holes 112 by means of other connection manners, for example, interference fitting and elastic connection.

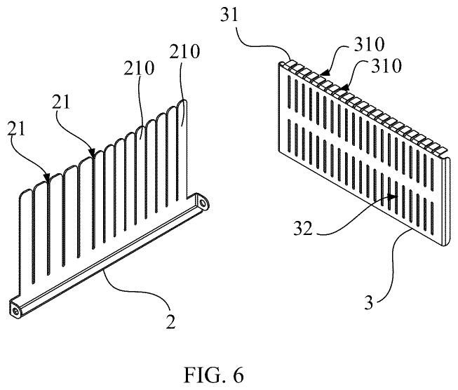

Reference is made to FIG. 3 and FIG. 6 together. In this embodiment, the bread slicer further includes a limiting plate 3, where each grid plate 2 includes a plurality of limiting grooves 21 formed at intervals, and the limiting plate 3 can be selectively inserted into the limiting grooves 21. Thus, when cutting the bread, the user can clamp the bread by means of the two grid plates 2, enable one end of the bread to abut against the limiting plate 3, and then operate the cutter to sequentially place it into the limiting grooves 21 to cut the bread, and the uniformly cut bread slices can be very conveniently obtained.

Of course, in other embodiments, the limiting plate 3 can be omitted when the bread does not need to be clamped and cut more stably.

Specifically, FIG. 6 shows that the plurality of limiting grooves 21 divide each grid plate 2 into a plurality of grid plate sheets 210, the widths of at least two of the grid plate sheets 210 are the same, and the widths of at least two of the grid plate sheets 210 are different. Thus, the user can cut the bread slices with the same thickness by means of the grid plate sheets 210 with the same width and the limiting grooves 21, and can also cut the bread slices with the different thicknesses by means of the grid plate sheets 210 with the different widths and the limiting grooves 21, thereby meeting the diversified demands of the user.

Reference is continuously made to FIG. 6. In this embodiment, one side of the limiting plate 3 is turned outwards to form a limiting portion 31, and the limiting portion 31 is provided with a plurality of clamping grooves 310; and when the limiting plate 3 is inserted into the limiting grooves 21, the grid plate sheets 210 are embedded into the clamping grooves 310 so as to limit sliding of the limiting plate 3 relative to the grid plates 2 on a horizontal plane, thereby preventing the cutting of the bread from being affected by the sliding of the limiting plate 3. The plurality of clamping grooves 310 are provided, so that after the distance between the two grid plates 2 is adjusted, when the limiting plate 3 is mounted on the grid plates 2, the grid plate sheets 210 can still be embedded into the corresponding clamping grooves 310. Of course, when the limiting plate 3 is not used, the limiting plate 3 can be pulled out from the limiting grooves 21 of the grid plates 2 in a vertical direction.

FIG. 4 shows that the base plate 1 and the limiting plate 3 each are provided with a plurality of through holes 32, thereby reducing the weight of the base plate 1 and the limiting plate 3, and facilitating carrying.

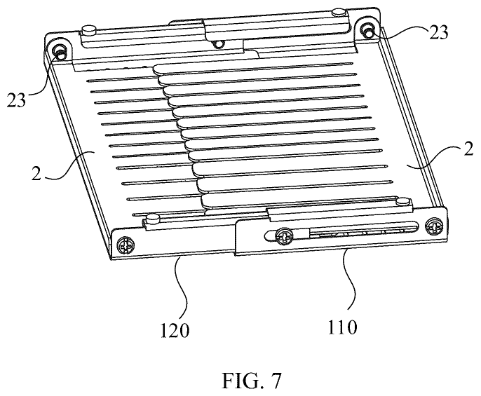

Reference is made to FIG. 3 to FIG. 7 together. In this embodiment, the two grid plates 2 are rotationally connected to the two opposite sides of the base plate 1, and the two grid plates 2 can respectively rotate relative to the base plate 1, so that the grid plates 2 are switched between open positions as shown in FIG. 3 and storage positions as shown in FIG. 7.

When the grid plates 2 are located at the open positions as shown in FIG. 3, the grid plates 2 are in contact with the side edges, the grid plates 2 are perpendicular to the base plate 1, the base plate 1 can stop further rotation of the grid plates 2, and the bread slicer is in the use state; and the limiting plate 3 can be inserted into the grid plates 2, so that the grid plate sheets 210 of the grid plates 2 are embedded into the clamping grooves 310 of the limiting plate 3, thereby fixing the grid plates 2 and then cutting the bread.

When the bread slicer needs to be stored after being used, the user can remove the limiting plate 3 on the grid plates 2 and then drive the grid plates 2 to rotate relative to the base plate 1, when the grid plates 2 are rotated to the storage positions as shown in FIG. 7, the two grid plates 2 are parallel to the base plate 1, then the two grid plates 2 and the base plate 1 are stacked, the space occupied by the bread slicer is reduced, and thus the bread slicer is convenient to store and carry.

Although the present disclosure is described with reference to several typical embodiments, it t should be understood that the used terms are illustrative and exemplary terms instead of restrictive terms. Since the present disclosure can be specifically implemented in various forms without departing from the spirit or essence of the disclosure, it should be understood that the above embodiments are not limited to any foregoing detail and should be broadly explained within the spirit and scope defined by the appended claims. Therefore, all changes and modifications falling within the claims or the equivalent scope thereof should be covered by the appended claims.

1. A bread slicer, comprising a base plate and two grid plates mounted on the base plate, wherein the two grid plates are respectively located on two opposite sides of the base plate, and the base plate and the two grid plates enclose a placement space for placing bread; and
the base plate comprises a first plate and a second plate, the second plate is slidably connected to the first plate, and the second plate is capable of sliding relative to the first plate, so as to adjust a distance between the two grid plates.

2. The bread slicer according to claim 1, wherein the first plate is provided with sliding grooves, the second plate is provided with sliding portions, and the sliding portions are embedded into the sliding grooves, so that the second plate is capable of sliding relative to the first plate.

3. The bread slicer according to claim 2, wherein there are two sliding grooves, and the two sliding grooves are respectively located on two opposite sides of the first plate; and the number and positions of the sliding portions match with the number and positions of the sliding grooves.

4. The bread slicer according to claim 2, wherein the first plate further comprises rail holes, and the second plate is in damping connection with the rail holes; and
when the second plate is moved to a target distance under the action of an external force, the second plate is kept in a fixed state relative to the first plate.

5. The bread slicer according to claim 4, wherein there are two rail holes, the two rail holes are respectively located on two opposite sides of the first plate, and the positions of the two rail holes match with the positions of the sliding grooves.

6. The bread slicer according to claim 4, wherein the second plate is provided with threaded connection members, and one end of each of the threaded connection members movably penetrates through the rail hole and is connected to the second plate.

7. The bread slicer according to claim 1, further comprising a limiting plate, wherein each of the grid plates comprises a plurality of limiting grooves formed at intervals, and the limiting plate is capable of being selectively inserted into the limiting grooves.

8. The bread slicer according to claim 7, wherein the plurality of limiting grooves divide each of the grid plates into a plurality of grid plate sheets, and the widths of at least two of the grid plate sheets are the same and/or the widths of at least two of the grid plate sheets are different.

9. The bread slicer according to claim 7, wherein one side of the limiting plate is turned outwards to form a limiting portion, and the limiting portion is provided with a plurality of clamping grooves; and
when the limiting plate is inserted into the limiting grooves, the grid plate sheets are embedded into the clamping grooves so as to limit sliding of the limiting plate relative to the grid plates.

10. The bread slicer according to claim 7, wherein the base plate and the limiting plate each are provided with a plurality of through holes.

11. The bread slicer according to claim 1, wherein the two grid plates are rotationally connected to the two opposite sides of the base plate, and the two grid plates are capable of respectively rotating relative to the base plate, so that the grid plates are switched between open positions and storage positions.

12. The bread slicer according to claim 11, further comprising a limiting plate, wherein each of the grid plates is provided with a plurality of limiting grooves, and the limiting plate is capable of being selectively inserted into the limiting grooves.

13. The bread slicer according to claim 12, wherein two opposite edges of the limiting plate are turned to form two limiting portions, and when the limiting plate is inserted into the limiting grooves, the two limiting portions respectively abut against outer sides of the two grid plates.

14. The bread slicer according to claim 12, wherein mounting strips are respectively arranged on the other pair of opposite side edges of the base plate, the two mounting strips and the base plate form an accommodating groove, and when the grid plates are located at the storage positions, the grid plates are accommodated in the accommodating groove.

15. The bread slicer according to claim 14, wherein each of the grid plates is provided with two connecting portions, the two connecting portions are arranged perpendicular to the grid plate and are respectively connected to the two mounting strips by means of bolts, and the connecting portions are rotationally connected to the bolts.

16. The bread slicer according to claim 15, wherein the connecting portions are welded with the grid plates.

17. The bread slicer according to claim 14, wherein each of the mounting strips is hollow, and connecting blocks are connected to end portions of the mounting strip.

18. The bread slicer according to claim 14, wherein a non-slip pad is arranged at the bottom of each of the mounting strips.

19. The bread slicer according to claim 12, wherein a support strip is arranged on a side edge of each of the grid plates opposite to a side edge close to the base plate, and the support strip and the grid plate are connected in an L shape.

20. The bread slicer according to claim 12, wherein the base plate, the grid plates and the limiting plate are made of stainless steel materials.
